(19) United States
(12) Patent Application Publication
(10) Pub. No.: US 2005/0170840 A1
(43) Pub. Date: Aug. 4, 2005

(54) System for allocating channels to calls via updatable priorities

(75) Inventor: Jiang Jon Cheng, Xi'an (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/515,695

(22) PCT Filed: Apr. 29, 2003
(86) PCT No.: PCT/IB03/01737

(30) Foreign Application Priority Data
May 27, 2002 (EP) 02077064.0

(51) Int. Cl. H04Q 7/20

(52) U.S. Cl. 455/452.2

(57) ABSTRACT

Systems (1) for allocating channels to calls by firstly searching its own cluster of channels and then searching subsequent clusters of channels until a free channel has been found are provided with updating options for updating cluster priorities in dependence of searching results. These systems (1) have integrated the updating and the call handling, which improves the efficiency of the self-organizing capabilities compared to separated updating and call handling. Said updating may comprise the increasing of a cluster priority for a cluster comprising an available channel and the decreasing of a cluster priority for a cluster not comprising an available channel. An original cluster may correspond with a cell receiving a request for allocating a channel to a call, and a subsequent cluster or borrowed cluster may then correspond with a neighboring cell. Said updating may be done for borrowed clusters and may not be done for original clusters.

The invention relates to a system for allocating a channel to a call and comprising a receiving system-part for receiving a request for said call and comprising a searching system-part for searching an available channel within a cluster of channels and comprising a selecting system-part for, in response to a first searching result, selecting, within said cluster, an available channel to be allocated to said call and for, in response to a second searching result, selecting, in dependence of at least one cluster priority, a next cluster to be searched by said searching system-part.

The invention also relates to a network-unit for communication with terminals via channels and comprising a system for allocating a channel to a call and comprising a receiving system-part for receiving a request for said call and comprising a searching system-part for searching an available channel within a cluster of channels and comprising a selecting system-part for, in response to a first searching result, selecting, within said cluster, an available channel to be allocated to said call and for, in response to a second searching result, selecting, in dependence of at least one cluster priority, a next cluster to be searched by said searching system-part, and to a method for allocating a channel to a call and comprising the steps of receiving a request for said call and of searching an available channel within a cluster of channels and of, in response to a first searching result, selecting, within said cluster, an available channel to be allocated to said call and of, in response to a second searching result, selecting, in dependence of at least one cluster priority, a next cluster to be searched, and to a processor program product for allocating a channel to a call and comprising the functions of receiving a request for said call and of searching an available channel within a cluster of channels and of, in response to a first searching result, selecting, within said cluster, an available channel to be allocated to said call and of, in response to a second searching result, selecting, in dependence of at least one cluster priority, a next cluster to be searched.

Such a system corresponds for example with a processor/memory and defines for example the order in which channels and clusters of channels are searched for finding an available channel and forms for example part of a network-unit like a base station for mobile communication (GSM etc.) or like a node for mobile communication (UMTS etc.) or like a base station for cordless communication (DECT etc.) etc.

A prior art system is known from U.S. Pat. No. 6,219,554, which discloses base stations and a base station controller and a switching center (one or more network-units) for communication with mobile units (terminals) via radio frequency channels and comprising said prior art system for allocating channels to requested calls. As described in the first part of the second column of U.S. Pat. No. 6,219,554, this system, upon receival of a request for a call, searches for an available channel in a cluster and, in response to a first searching result (having found an available channel in this cluster), selects an available channel to be allocated to said call. As described in the last part of the first column of U.S. Pat. No. 6,219,554, in response to a second searching result (not having found any available channel in this cluster), this system selects a next cluster to be searched.

The known system is disadvantageous, inter alia, due to being self-organizing inefficiently: during low traffic periods, a Dynamic Frequency Association (DFA) technique is activated having a scanning mode for recalculating channel probabilities and for resorting a list with channels based upon their recalculated probabilities. This scanning mode is separated from a call handling mode.

It is an object of the invention, inter alia, to provide a system as defined in the preamble which is self-organizing (more) efficiently.

The system according to the invention is characterized in that said system comprises an updating system-part for updating at least one cluster priority in dependence of at least one searching result.

Said updating system-part updates at least one cluster priority in dependence of at least one searching result or, in other words, a cluster priority is updated in response to a searching result of having found or not having found an available channel. So, contrary to the prior art which discloses a scanning mode completely separated from a call handling mode, the system according to the invention has integrated the updating and the call handling.

The invention is based upon an insight, inter alia, that separated recalculations and resortings on the one hand and call handlings on the other hand are inefficient, and is based upon a basic idea, inter alia, that updating and call handling can be combined.

The invention solves the problem, inter alia, of providing a more efficient system for allocating channels to calls, and is advantageous, inter alia, in that this system has integrated the updating and the call handling.

A first embodiment of the system according to the invention as defined in claim 2 is advantageous in that the updating system-part comprises an increasing/decreasing system-part for increasing a cluster priority for a cluster comprising an available channel and for decreasing a cluster priority for a cluster not comprising an available channel.

Said increasing/decreasing of a cluster priority in dependence of said cluster having/not having a free channel will generally improve the efficiency of one or more following searches.

A second embodiment of the system according to the invention as defined in claim 3 is advantageous in that at least one cluster of channels corresponds with at least one original cluster being a cell comprising at least two channels.

Said cluster of channels corresponding with an original cluster in the form of a cell introduces a new scheme in addition to Fixed Channel Allocation (FCA), Dynamic Channel Allocation (DCA) and Hybrid Channel Allocation (HCA).

A third embodiment of the system according to the invention as defined in claim 4 is advantageous in that at least one next cluster of channels corresponds with at least one borrowed cluster being a neighboring cell comprising channels to be borrowed, with said updating system-part updating cluster priorities for borrowed clusters and not updating cluster priorities for original clusters.

Said next cluster of channels corresponding with a borrowed cluster in the form of a neighboring cell, together with said partial updating, introduces an advanced new scheme.

A fourth embodiment of the system according to the invention as defined in claim 5 is advantageous in that the searching system-part comprises a detecting system-part for detecting channels being free or not.

This searching system-part comprising the detecting system-part generates one or more search results indicative for at least one channel being free or not.

A fifth embodiment of the system according to the invention as defined in claim 6 is advantageous in that the searching system-part comprises a comparing system-part for comparing channel priorities with each other.

This searching system-part comprising the comparing system-part generates one or more search results indicative for at least one channel priority.

A sixth embodiment of the system according to the invention as defined in claim 7 is advantageous in that the searching system-part comprises a comparing system-part for comparing channel interference signals with threshold signals.

This searching system-part comprising the comparing system-part generates one or more search results indicative for at least one channel interference. Said threshold signals may be predefined signals or may be other channel interference signals, in which case channel interference signals are compared with each other.

It should be noted that U.S. Pat. No. 6,219,554 discloses channel probabilities, which differ from channel priorities and which indicate a chance of being available or not. These channel probabilities are recalculated and resorted separately from the call handling. U.S. Pat. No. 6,219,554 does not disclose any cluster priorities. Usually a cluster comprises two or more channels.

Embodiments of the network-unit according to the invention, of the method according to the invention and of the processor program product according to the invention correspond with the embodiments of the system according to the invention.

These and other aspects of the invention will be apparent from and elucidated with reference to the embodiments(s) described hereinafter.

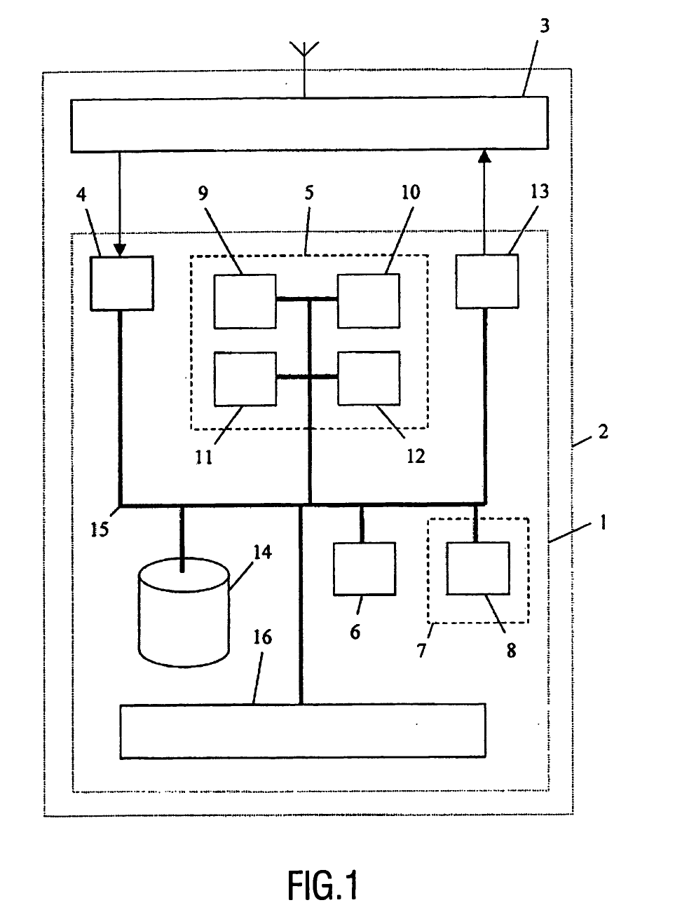

FIG. 1 illustrates in block diagram form a network-unit according to the invention comprising a system according to the invention, and

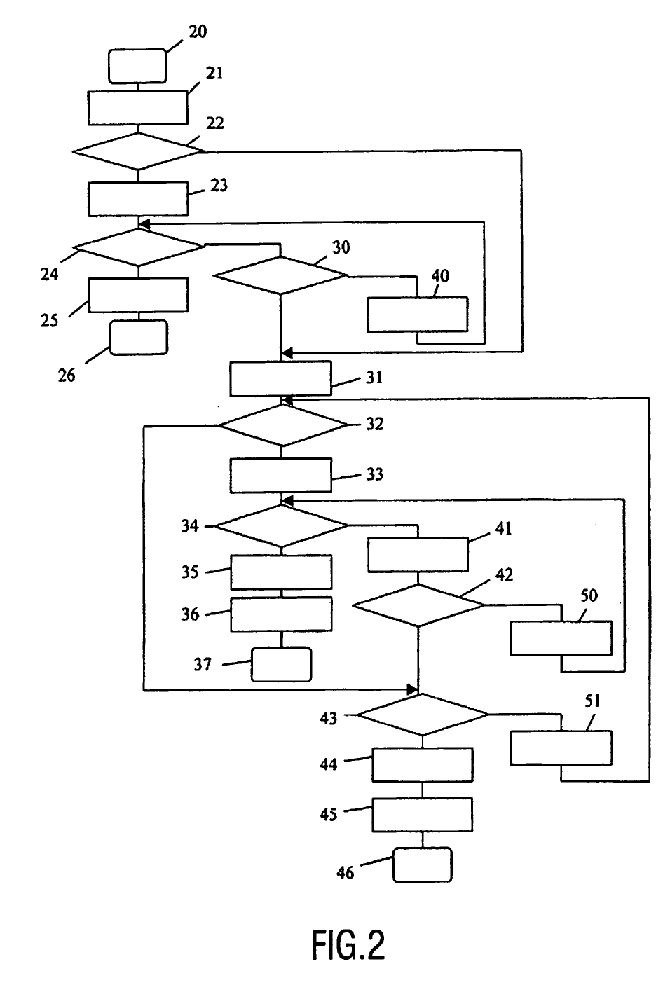

FIG. 2 illustrates a flow chart elucidating a method according to the invention and a computer program product according to the invention.

The network-unit 2 according to the invention comprises a system 1 according to the invention and a transceiver 3 of which an in/output is coupled to an antenna for (radio) communication with (mobile) terminals. System 1 comprises a receiving system-part 4 of which an input is coupled to an output of transceiver 3 and of which an output is coupled to a bus 15. System 1 further comprises a searching system-part 5 comprising a detecting system-part 9 and a first comparing system-part 10 and a second comparing system-part 11 and a further system-part 12 all coupled to bus 15. System 1 also comprises a selecting system-part 6 and an updating system-part 7 comprising an increasing/decreasing system-part 8 all coupled to bus 15, and comprises a memory 14 and a (bus) controller 16 both coupled to bus 15 and a transmitting system-part 13 of which an output is coupled to an input of transceiver 3 and of which an input is coupled to bus 15.

The system 1 according to the invention functions as follows. A request for a new call to be set up or for an existing call requiring a handover/handoff arrives at transceiver 3, which extracts information from this request and/or converts (parts of) this request into information and supplies digital information to system 1 for example corresponding with a processor system 4-16 comprising a processor (all system-parts 4-13+bus 15+controller 16) and a memory 14. Receiving system-part 4 receives this digital information and informs controller 16, which instructs (via bus 15) receiving system-part 4 to put (parts of) this digital information on bus 15 and/or instructs searching system-part 5 to start searching for a free nominal channel in an original cluster of channels for example corresponding with the cell served by network-unit 2.

Thereto, searching system-part 5 comprises a detecting system-part 9 which (via bus 15) consults memory 14 for detecting any free channels in this cluster. Then, there are two possible outcomes, a first outcome indicating that there are one or more channels still free, and a second outcome indicating that there are no channels free in this cluster.

According to the first outcome, first comparing system-part 10 then compares channel priorities of the channels still available with each other, and second comparing system-part 11 compares the channel interference signal of the free channel having the highest channel priority with a threshold signal. In case an interference criterium is satisfied, this free channel having the highest channel priority is for example under control of controller 16 selected by selecting system-part 6 and allocated to the request (first search result). In case an interference criterium is not satisfied, a channel interference signal of a next free channel having the one-but-highest channel priority is compared with a threshold signal, etc. until either an interference criterium is satisfied resulting in the allocation of a free channel to the request (first search result) or until there are no more free channels left in this original cluster resulting in the second outcome (second search result).

According to the second outcome, selecting system-part 6 for example under control of controller 16 selects a next cluster to be searched by searching system-part 5. Thereto, selecting system-part 6 consults memory 14 and selects the next cluster of channels with the highest cluster priority, for example via further system-part 12 corresponding with a third comparing system-part for comparing cluster priorities with each other. This next cluster of channels for example corresponds with a neighboring cell served by for example a neighboring network-unit.

Searching system-part 5 is instructed to start searching for a free channel in this next cluster of channels, again via detecting system-part 9 which (via bus 15) consults memory 14 for detecting any free channels in this next cluster. Then, there are two possible outcomes, a third outcome indicating that there are one or more channels still free, and a fourth outcome indicating that there are no channels free in this next cluster.

According to the third outcome, first comparing system-part 10 then compares channel priorities of the channels still available with each other, and second comparing system-part 11 compares the channel interference signal of the free channel having the highest channel priority with a threshold signal. In case an interference criterium is satisfied, this free channel having the highest channel priority is selected by selecting system-part 6 and allocated to the request (third search result corresponding with the first search result). But now the cluster priority of this next cluster is for example under control of controller 16 updated by updating system-part 7, for example comprising increasing/decreasing system-part 8 which increases the cluster priority of this next cluster for example by the value “one”. In case an interference criterium is not satisfied, a channel interference signal of a next free channel having the one-but-highest channel priority is compared with a threshold signal, etc. until either an interference criterium is satisfied resulting in the allocation of a free channel to the request (third search result corresponding with the first search result), whereby the cluster priority of this next cluster is updated by updating system-part 7, for example comprising increasing/decreasing system-part 8 which increases the cluster priority of this next cluster for example by the value “one”, or until there are no more free channels left in this next cluster resulting in the fourth outcome (fourth search result corresponding with the second search result), whereby the cluster priority of this next cluster is updated by updating system-part 7, for example comprising increasing/decreasing system-part 8 which decreases the cluster priority of this next cluster for example by the value “one”.

According to the fourth outcome, selecting system-part 6 selects a further next cluster to be searched by searching system-part 5. Thereto, selecting system-part 6 consults memory 14 and selects the further next cluster of channels with the next highest cluster priority, for example via further system-part 12 corresponding with a third comparing system-part for comparing cluster priorities with each other. This further next cluster of channels for example corresponds with a further neighboring cell served by for example a further neighboring network-unit. Searching system-part 5 is instructed to start searching for a free channel in this further next cluster of channels etc., until finally either a channel is allocated to the request, or the request is denied.

As soon as a channel has been allocated to the request, the terminal is informed via transmitting system-part 13 and transceiver 3, etc.

So, the invention relates to a system 1 for allocating a channel to a call and comprising a receiving system-part 4 for receiving a request for said call and comprising a searching system-part 5 for searching an available channel within a cluster of channels and comprising a selecting system-part 6 for, in response to a first searching result, selecting, within said cluster, an available channel to be allocated to said call and for, in response to a second searching result, selecting, in dependence of at least one cluster priority, a next cluster to be searched by said searching system-part, and is characterized in that said system 1 comprises an updating system-part 7 for updating at least one cluster priority in dependence of at least one searching result (like for example the third or fourth searching result).

The invention is based upon an insight, inter alia, that prior art separated recalculations and resortings on the one hand and call handlings on the other hand are inefficient, and is based upon a basic idea, inter alia, that updating and call handling can be combined. The invention solves the problem, inter alia, of providing a more efficient system for allocating channels to calls, and is advantageous, inter alia, in that this system has integrated the updating and the call handling.

System 1 may correspond with a processor system 4-16 comprising a processor (all system-parts 4-13+bus 15+controller 16) and a memory 14, but may also correspond with memory 14 and controller 16, with system-parts 4-13 being implemented in software. Or system 1 corresponds with system-parts 4-13 and memory 14, with system-parts 4-13 being implemented in hardware modules. A cluster of channels may correspond with a cell, but may also correspond with a part of a cell, with several cells, or with a group of channels not being cell-organized. Said interference signal may correspond with a channel to interference ratio, a signal to interference ratio, an interference level, an interference power, a quality of service or QoS etc. with further signals not to be excluded.

A systems 1 for allocating channels to calls having a searching/selecting option for firstly searching its own cluster of channels and secondly searching subsequent clusters of channels until a free channel has been found and thirdly selecting this free channel, is provided with an updating option for updating one or more cluster priorities in dependence of searching results. Said updating may comprise the increasing of a cluster priority for a cluster comprising an available channel and the decreasing of a cluster priority for a cluster not comprising an available channel, but other updating options as well as other increasing/decreasing values are not to be excluded. Said updating may be done for borrowed clusters and may not be done for original clusters, but could also be done for all clusters, or for just some of the borrowed clusters, and the updating could be done more individually per cluster (like by introducing different increasing/decreasing values) and/or dependently upon more factors (like taking into account the kind of call, the Quality of Service or QoS, the priority of the call itself etc.).

In the flow chart shown in FIG. 2 the following blocks have the following meaning:
Block 20: Start, goto 21.
Block 21: Arrival of a request, goto 22.
Block 22: Search original cluster for free channels, if yes, goto 23, if no, goto 31.
Block 23: Select nominal free channel with highest channel prio, goto 24.
Block 24: Compare interference signal with threshold, if ok, goto 25, if not, goto 30.
Block 25: Assign channel to call, goto 26.
Block 26: Stop.
Block 30: Last free nominal channel, if yes, goto 31, if no, goto 40.
Block 31: Select next cluster with highest cluster prio, goto 32.
Block 32: Search next cluster for free channels, if yes, goto 33, if no, goto 43.
Block 33: Select free channel with highest (borrowing) channel prio, goto 34.
Block 34: Compare interference signal with threshold, if ok, goto 35, if not, goto 41.
Block 35: Assign channel to call, goto 36.
Block 36: Update (cluster) priorities (by increasing), goto 37.
Block 37: Stop.
Block 40: Select next nominal free channel with one-but-highest prio, goto 24.
Block 41: Update (cluster) priorities (by decreasing), goto 42.
Block 42: Last free nominal channel, if yes, goto 43, if no, goto 50.
Block 43: Last next cluster, if yes, goto 44, if no, goto 51.
Block 44: Block the request, goto 45.
Block 45: Update (cluster) priorities (by decreasing), goto 46.
Block 46: Stop.
Block 50: Select next free channel according to (borrowing) channel prio, goto 34.
Block 51: Select further next cluster with highest cluster prio, goto 32.

In the flow chart shown in FIG. 2 the following method steps and processor program product functions are present: Start (Block 20, goto 21). A request has arrived (Block 21, goto 22) and is detected. The original cluster is searched for free channels (Block 22, if found, goto 23, if not found, goto 31). The nominal free channel with the highest channel prio is selected (Block 23, goto 24). The interference signal of this selected nominal channel is compared with one or more thresholds (Block 24, if ok, goto 25, if not, goto 30). The channel is assigned to the call (Block 25, goto 26). Stop (Block 26). The selected nominal channel is checked for being the last free channel (Block 30, if yes, goto 31, if no, goto 40). The next cluster with the highest cluster prio is selected (Block 31, goto 32). This next cluster is searched for free channels (Block 32, if found, goto 33, if not found, goto 43). The free channel with the highest borrowing channel prio is selected (Block 33, goto 34). The interference signal of this channel is compared with one or more thresholds (Block 34, if ok, goto 35, if not, goto 41). The channel is assigned to the call (Block 35, goto 36). Update (cluster) priorities (by increasing) (Block 36, goto 37). Stop (Block 37). The next nominal free channel with one-but-highest prio is selected (Block 40, goto 24). Update (cluster) priorities (by decreasing) (Block 41, goto 42). The selected nominal channel is checked for being the last free channel (Block 42, if yes, goto 43, if no, goto 50). The next cluster is checked for being the last cluster (Block 43, if yes, goto 44, if no, goto 51). The request is blocked (Block 44, goto 45). Update (cluster) priorities (by decreasing) (Block 45, goto 46). Stop (Block 46). The next free channel is selected according to borrowing channel prio (Block 50, goto 34). The further next cluster with highest cluster prio is selected (Block 51, goto 32).

It is observed that each channel usually will have at least one channel priority: this one channel priority then indicates the priority within its own cluster as well as the priority when being borrowed by another (neighboring) cluster. However, it is not to excluded that each channel may have two or more channel priorities: a first channel priority to be used within its own cluster and a second (borrowing) channel priority to be used when being borrowed by another (neighboring) cluster. This borrowing channel priority may even be different for different borrowing clusters.

The method according to the invention for allocating a channel to a call comprises the steps of receiving (21) a request for said call and of searching (22) an available channel within a cluster of channels and of, in response to a first searching result, selecting (23,24,25), within said cluster, an available channel to be allocated to said call and, in response to a second searching result, selecting (31), in dependence of at least one cluster priority, a next cluster to be searched (32), characterized in that said method comprises the step of updating (36,41,45) at least one cluster priority in dependence of at least one searching result.

Further steps are not to be excluded and may correspond with any step disclosed in the description of FIG. 1 and/or with any further block described in FIG. 2.

The processor program product according to the invention for allocating a channel to a call comprises the functions of receiving (21) a request for said call and of searching (22) an available channel within a cluster of channels and of, in response to a first searching result, selecting (23,24,25), within said cluster, an available channel to be allocated to said call and, in response to a second searching result, selecting (31), in dependence of at least one cluster priority, a next cluster to be searched (32), characterized in that said processor program product comprises the function of updating (36,41,45) at least one cluster priority in dependence of at least one searching result.

Further functions are not to be excluded and may correspond with any function disclosed in the description of FIG. 1 and/or with any further block described in FIG. 2.

1. System for allocating a channel to a call and comprising a receiving system-part for receiving a request for said call and comprising a searching system-part for searching an available channel within a cluster of channels and comprising a selecting system-part for, in response to a first searching result, selecting, within said cluster, an available channel to be allocated to said call and for, in response to a second searching result, selecting, in dependence of at least one cluster priority, a next cluster to be searched by said searching system-part, characterized in that said system comprises an updating system-part for updating at least one cluster priority in dependence of at least one searching result.

2. System according to claim 1, characterized in that the updating system-part comprises an increasing/decreasing system-part for increasing a cluster priority for a cluster comprising an available channel and for decreasing a cluster priority for a cluster not comprising an available channel.

3. System according to claim 2, characterized in that at least one cluster of channels corresponds with at least one original cluster being a cell comprising at least two channels.

4. System according to claim 3, characterized in that at least one next cluster of channels corresponds with at least one borrowed cluster being a neighboring cell comprising channels to be borrowed, with said updating system-part updating cluster priorities for borrowed clusters and not updating cluster priorities for original clusters.

5. System according to claim 1, characterized in that the searching system-part comprises a detecting system-part for detecting channels being free or not.

6. System according to claim 1, characterized in that the searching system-part comprises a comparing system-part for comparing channel priorities with each other.

7. System according to claim 1, characterized in that the searching system-part comprises a comparing system-part for comparing channel interference signals with threshold signals.

8. Network-unit for communication with terminals via channels and comprising a system for allocating a channel to a call and comprising a receiving system-part for receiving a request for said call and comprising a searching system-part for searching an available channel within a cluster of channels and comprising a selecting system-part for, in response to a first searching result, selecting, within said cluster, an available channel to be allocated to said call and for, in response to a second searching result, selecting, in dependence of at least one cluster priority, a next cluster to be searched by said searching system-part, characterized in that said system comprises an updating system-part for updating at least one cluster priority in dependence of at least one searching result.

9. Method for allocating a channel to a call and comprising the steps of receiving a request for said call and of searching an available channel within a cluster of channels and of, in response to a first searching result, selecting, within said cluster, an available channel to be allocated to said call and, in response to a second searching result, selecting, in dependence of at least one cluster priority, a next cluster to be searched, characterized in that said method comprises the step of updating at least one cluster priority in dependence of at least one searching result.

10. Processor program product for allocating a channel to a call and comprising the functions of receiving a request for said call and of searching an available channel within a cluster of channels and of, in response to a first searching result, selecting, within said cluster, an available channel to be allocated to said call and, in response to a second searching result, selecting, in dependence of at least one cluster priority, a next cluster to be searched, characterized in that said processor program product comprises the function of updating at least one cluster priority in dependence of at least one searching result.
